(19) United States
(12) Patent Application Publication
(10) Pub. No.: US 2015/0120340 A1
(43) Pub. Date: Apr. 30, 2015

(54) DYNAMIC SEAT RESERVATIONS

(71) Applicant: Elwha LLC, Bellevue, WA (US)

(72) Inventors: Jesse R. Cheatham, III, Seattle, WA (US); Roderick A. Hyde, Redmond, WA (US); Jordin T. Kare, Seattle, WA (US); Lowell L. Wood, JR., Bellevue, WA (US)

(21) Appl. No.: 14/063,708

(22) Filed: Oct. 25, 2013

(51) Int. Cl. G06Q 10/02

(52) U.S. Cl. CPC G06Q 10/02
USPC 705/5

(57) ABSTRACT

A seating system for selectively reserving seats during an event includes a seating control system configured to place a plurality of seats in an open position, such that a patron is able to sit in the seats, receive reservation data identifying reserved seats from the plurality of seats, and place each reserved seat into a closed position, such that a patron is not able to sit in the reserved seat, based on the reservation data.

### BACKGROUND

Venues such as theaters, sports arenas, and stadiums often use reserved seating for events held at the venue such that a patron can purchase a ticket for a particular seat within the venue, and expect the seat to be available upon arrival at the event. However, at times other patrons will sometimes sit in seats besides their own (e.g., in a seat reserved for another patron), resulting in a sometimes uncomfortable situation for the patron for whom the seat is reserved.

### SUMMARY

One embodiment relates to a seating system for selectively reserving seats during an event, comprising a seating control system configured to place a one or more seats from a plurality of seats in an open position, such that a patron is able to sit in the one or more seats; receive reservation data identifying reserved seats from the plurality of seats; and place each reserved seat into a closed position, such that a patron is not able to sit in the reserved seat, based on the reservation data.

Another embodiment relates to a seating reservation system for dynamically reserving seats for an event, comprising a seat including an indicator device, the indicator device configured to provide at least one of a first indication indicating the seat is unreserved and a second indication indicating the seat is reserved; and a seating control system configured to receive reservation data regarding the seat and to control operation of the indicator device to provide at least one of the first indication and the second indication based on the reservation data.

Another embodiment relates to a seating system, comprising a seating control system configured to receive reservation data for an event at a venue; determine a first seating distribution for the venue based on the reservation data, the first seating distribution defining first eligibility requirements for patrons to sit in a plurality of seats; and determine a second seating distribution for the venue during the event, the second seating distribution defining second eligibility requirements for patrons to sit in the plurality of seats.

Another embodiment relates to a method of reserving seats at a venue during an event, comprising receiving seating data for a seat, the seat enabling a patron to sit during an event; configuring the seat in a first configuration based on the seating data; and reconfiguring the seat during the event in a second configuration based on an input received during the event.

Another embodiment relates to a method of dynamically controlling seating at an event, comprising receiving seating data for an event at a venue; determining a first seating distribution for the venue based on the seating data, the first seating distribution defining first eligibility requirements for patrons to sit in a plurality of seats; and determining a second seating distribution for the venue during the event, the second seating distribution defining second eligibility requirements for patrons to sit in the plurality of seats.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a seating system according to one embodiment.

FIG. 2 is a perspective view of a seat in an open position according to one embodiment.

FIG. 3 is a perspective view of the seat of FIG. 2 in a closed position.

FIG. 4 is a perspective view of a seat in an open position according to another embodiment.

FIG. 5 is a perspective view of the seat of FIG. 4 in a closed position.

FIG. 6 is a partial perspective view of a portion of a seat according to one embodiment.

FIG. 7 is a partial perspective view of a seating area access control device according to one embodiment.

FIG. 8 is a schematic representation of a seating area according to one embodiment.

FIG. 9 is a schematic representation of a seating area according to another embodiment.

FIG. 10 is a block diagram of a control system for a seating system according to one embodiment.

FIG. 11 is a front view of a mobile device configured for use by patrons according to one embodiment.

FIG. 12 is a block diagram of a method of operating a seating system according to one embodiment.

FIG. 13 is a block diagram of a method of operating a seating system according to another embodiment.

FIG. 14 is a block diagram of a method of operating a seating system according to another embodiment

FIG. 15 is a block diagram of a method of operating a seating system according to another embodiment

### DETAILED DESCRIPTION

In the following detailed description, reference is made to the accompanying drawings, which form a part thereof In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Referring to the figures generally, various embodiments disclosed herein relate to a dynamic seating system (e.g., a seating reservation system) that can facilitate reserving seats for patrons (e.g., ticket or reservation holders). In some embodiments, one or more seats within a seating area can initially be positioned in an unlocked (e.g., open, available, or unreserved) position, such that a patron can sit in the seat, or alternatively, such that the seat provides an indication that the seat is unreserved, or available. Based on seating reservation data, the seating system can move reserved seats to a locked (e.g., closed, unavailable, or reserved) position, such that a patron cannot sit in the seat, or alternatively, such that the seat provides an indication that the seat is reserved, or unavailable. Subsequently, a patron can unlock the seat by presenting a ticket or reservation (e.g., via a ticket scanner, etc. provided on or near the seat). As such, potentially uncomfortable situations of patrons having to ask other patrons to vacate seats can be avoided. The seating system can be dynamically operated such that the status of various seats or seating areas can be changed or updated during an event based on a wide variety of factors. In some embodiments, seat positioning or indicator states may be determined after the receipt of seating reservation data. Once data is received that a given seat is reserved, the seat can be placed into a locked position and/or the seat can provide an indication that it is reserved. Alternatively, once data is received that the seat is unreserved, the seat can be placed into an unlocked position and/or the seat can provide an indication that it is unreserved. These actions can be taken regardless of the previous state of the seat.

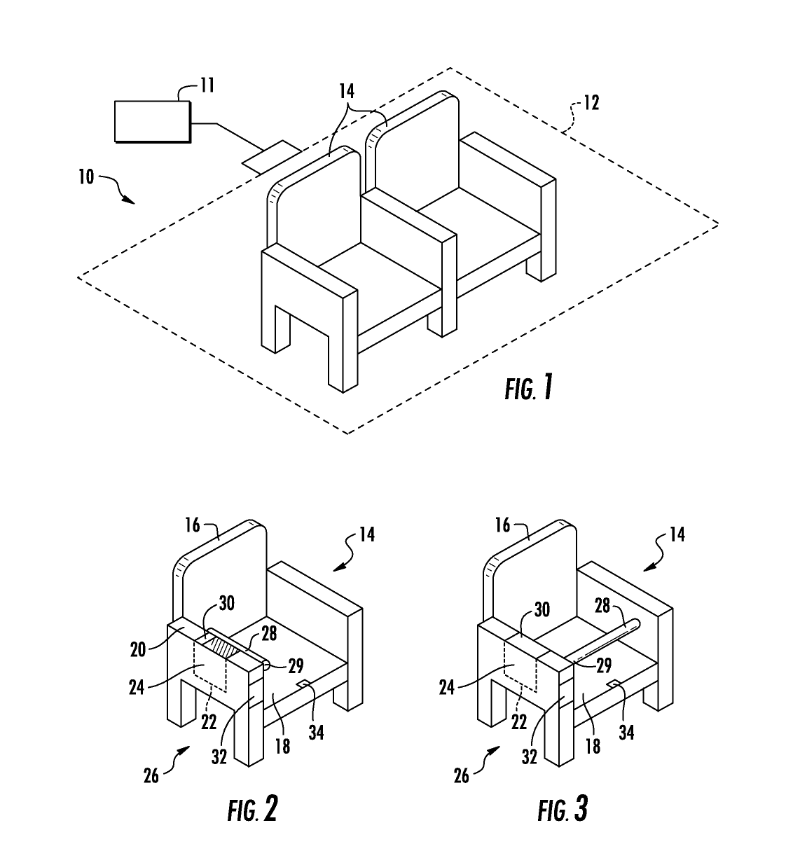

Referring now to FIG. 1, a seating reservation system is shown as seating system 10 according to one embodiment. System 10 includes seat control system 11 configured to control operation of one or more seats 14 provided within seating area 12. Seating area 12 can be part of any of a wide variety of venues such as theaters, sports arenas or stadiums, vehicles such as airplanes and boats, and the like. The venue can include any number of seating areas and seats, and the number of seats within different seating areas can vary from a single seat to multiple seats. Furthermore, while various embodiments disclosed herein may be described in connection with a fixed venue such as a stadium, sports arena, or theater, it should be understood that the teachings herein can be applied to any seating area where it may be desirable to provide enhanced seating reservation or seat control features such as those disclosed herein, including vehicles such as airplanes, trains, buses, and other seating areas or venues.

As discussed in greater detail below, in general, seat control system 11 is configured to control the status one or more of seats 14 (i.e., control movement of the seat between an open and closed position) based on a variety of factors. The factors may include seat reservation data indicating individual seats reserved by specific patrons, groups of seats that may be available to certain groups of patrons, and the like. Additionally, control system 11 can control the status (e.g., reserved/unreserved) of seats 14 based on a number of other factors, including occupancy levels in one or more seating areas (e.g., to encourage patrons to move to certain sections), elapsed time (e.g., to permit lower price ticket holders to sit in higher priced seats after a certain amount of elapsed time), or event activity (e.g., to make certain seats available based on certain event activities such as being beyond the seventh inning of a baseball game, or being after the third quarter of a football game).

Referring to FIGS. 2-3, seat 14 is shown according to one embodiment and includes a back support or back rest 16, a seat support or seat rest 18, and optionally, one or more arm supports or arm rests 20. In some embodiments, seat 14 further includes a storage compartment 22 defining a storage area 24. Storage compartment 22 may be used to hold or store various items such as food items, beverages, personal items of a patron, and the like, and may include a beverage holder, food holder, or similar items. As shown in FIGS. 2-3, in one embodiment storage compartment 22 can be disposed on or within a portion of arm rest 20. In other embodiments, storage compartment 22 can be provided at different areas of seat 14, such as being integrated into the back or seat rest, etc. In yet further embodiments, storage compartment 22 can take the form of a more conventional cup holder or similar device.

According to one embodiment, seat 14 is selectively reconfigurable, or repositionable, between an open position, shown in FIG. 2, and a closed position, shown in FIG. 3. In the open position, a patron can sit in the seat, or the seat otherwise provides an indication that the seat is available, or unreserved. In the closed position, a patron is prevented from sitting in the seat, or the seat otherwise provides an indication that the seat is not available, or reserved. In one embodiment, reconfiguring seat 14 between the open and closed positions includes actuating seat locking mechanism 26. As shown in FIGS. 2-3, seat locking mechanism 26 includes locking member 28 and locking panel 30. Locking member 28 and locking panel 30 provide selective locking for seat rest 18 (e.g., to prevent a patron from sitting on seat rest 18 of seat 14) and storage compartment 22 (e.g., to prevent a patron from accessing storage area 24), respectively.

In one embodiment, locking member 28 is an elongated member that pivots between an open position, as shown in FIG. 2, and a closed position, as shown in FIG. 3. For example, locking member 28 can be a bar, plate, rod, etc. configured to be positioned adjacent arm rest 20 when seat 14 is in the open position (see FIG. 2). As such, a patron can sit unobstructed in seat 14. Upon moving to the closed position (see FIG. 3), locking member 28 can extend generally over seat rest 18, essentially prohibiting a patron from sitting in seat 14. Locking member 28 can pivot about pivot point 29 between the open and closed positions. In alternative embodiments, rather than pivoting between the open and closed positions, locking member can move in different ways (e.g., by moving in a linear, translational fashion between an open and a closed position). Furthermore, while FIGS. 2-3 show a single locking member 28 coupled to one arm rest 20, in various alternative embodiments, more than one locking member 28 may be used (e.g., such that a locking member extends from both arm rests 20), and locking member 28 can be coupled to other portions of seat 14 (e.g., back rest 16, seat rest 18, combinations thereof). Further yet, locking member 28 can include one or more moveable spikes that may discourage a patron from sitting in seat 14 when in the closed position.

Referring further to FIGS. 2-3, locking panel 30 can selectively provide access to storage area 24 of storage compartment 22 to enable a patron to access food, beverages, personal items, etc. that may be stored in storage area 24. In one embodiment, locking panel 30 can be a generally planar member that can move (e.g., slide, rotate, lift) between an open position and a closed position. In other embodiments, locking panel can be a bar, a screened member, a fabric member, and so on. Furthermore, while a single storage compartment 22 and locking panel 30 are shown as being integrated into arm rest 20, in various other embodiments, more than one storage compartment can be provided, and storage compartment 22 can be provided in a variety of locations, either integrated into or coupled to various components of seat 14. In one embodiment, locking panel 30 is configured to slide between an open position, where a patron can access items within storage area 24, and a closed position, where a patron cannot access items within storage area 24, based on seat 14 similarly moving between the open and closed positions.

According to an alternative embodiment, rather than using a discreet locking member 28, arm rest 20 can be configured to act both as an arm rest (when seat 14 is in an open position) and as a locking member (when seat 14 is in a closed position). For example, arm rest 20 (or a portion thereof) can be configured to rotate (in a similar manner to that described with respect to locking member 28) between an open position, such that a patron can sit in seat 14, to a closed position, where all or a portion of arm rest 20 extends over seat rest 18 or otherwise prevents or inhibits a patron from sitting in seat 14.

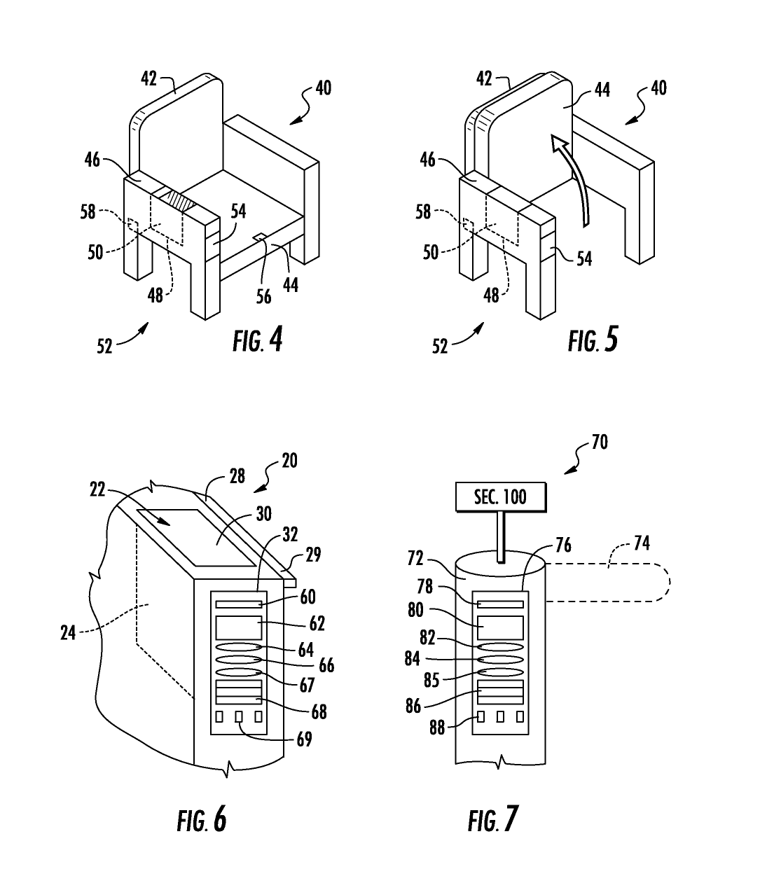

According to yet further embodiments, rather than utilizing locking member 28 or arm rest 20 to reposition seat 14 between an open position and a closed position, seat rest 18 can be configured to provide locking features for seat 14. For example, referring to FIGS. 4-5, seat 40 is shown according to one embodiment and includes various features similar to those discussed with respect to seat 14, including back rest 42, seat rest 44, one or more arm rests 46, storage compartment 48, and storage area 50. Seat rest 44 may be configured to rotate between a raised, or collapsed position, where the seat rest is rotated generally upward toward the back rest (as shown in FIG. 5), and a lowered position, where seat rest 18 is in a position suitable for seating (as shown in FIG. 4). Locking mechanism 26 can be configured such that seat rest 44 is maintained in a locked position by way of a seat rest locking mechanism 58.

Referring back to FIGS. 2-3, seat 14 further includes seat input/output device 32 and occupancy sensor 34. As discussed in greater detail below, device 32 is configured to receive various inputs from patrons, such as ticket or reservation information, etc. Device 32 is further configured to provide various outputs to patrons, such as an indication of whether a seat is reserved or available, etc. Occupancy sensor 34 is configured to provide an indication of whether seat 14 is currently occupied by, for example, sensing the presence of a patron's weight on seat rest 18, back rest 16, or another portion of seat 14. Sensor 34 can be any suitable sensor type (e.g., a pressure sensor) according to various alternative embodiments. Sensor 34 may consist of a proximity sensor, configured to sense the presence of a patron in the seat by blockage of an optical path (e.g., a light path between the arm rests), by reflection of an ultrasonic wave, by radar (e.g., using micro-impulse radar), by a camera, or the like. In some embodiments, seat rest 18 or back rest 16 are movable and spring loaded, such that they are only maintained in an open position when occupied by a human or some other sizable object. In such embodiments, occupancy sensor 34 can operate by sensing the configuration of the seat. As shown in FIGS. 4-5, seat 40 can similarly include seat input/output device 54 and occupancy sensor 56 that operate in a similar manner to device 32 and sensor 34.

In some embodiments occupancy sensor 34 can be used to detect the presence of a patron in an unreserved seat. Seat control system 11 may provisionally assign the occupied seat to the patron. This provisional assignment may, if the patron occupies the seat for more than a specified time period, be upgraded to a reserved status. On the other hand, if the occupant leaves the seat before the specified time period is complete (either to move to another seat, or just to go to a restroom or concessions stand) he may lose his provisional assignment. Or, if another patron reserves and/or pays for the seat during the provisional assignment period, the current occupant may lose his provisional rights to the seat. Occupancy sensor 34 can be used to detect the improper presence of a patron in a reserved seat. Seat control system 11 may respond to such an improper occupation in several ways. One response is to inform a venue official (e.g., by transmitting an appropriate communication). Another response is to provide a local indication at the seat, e.g., a flashing red light, a buzzer, or the like (e.g., using a suitable output device such as those disclosed herein); such indication may be different from, and more aggressive than, indications that a seat is reserved, locked, or unavailable. Another response that seat control system 11 can take to such an improper occupation is to immediately lock the seat if the occupant temporarily leaves it (e.g., to go to a restroom or to a concessions stand).

Referring now to FIG. 6, an armrest portion of seat 14 including input /output device 32 is shown in greater detail according to one embodiment. As shown in FIG. 6, device 32 can be integrated into arm rest 20 and can include one or more of receptacle 60 (e.g., a slot, card or ticket reader), image input device 62 (e.g., a scanner, barcode reader, camera), audio input device 64, audio output device 66, radio-frequency output device 67, visual output device 68, and one or more buttons 69. According to various alternative embodiments, more of fewer components than those shown in FIG. 6 may be provided as part of device 32, and certain components may be integrated into single components or further divided into sub-components.

Receptacle 60 can be a ticket reader, card reader, or similar device (e.g., a radio frequency identification (RFID) reader) configured to receive at least a portion of a ticket or card (e.g., a reservation) and “read” the ticket or card (in a manner similar to a credit card or keycard reader). Receptacle 78 may include a physical slot into which a card or ticket is inserted, or may electronically read a proximate, but not inserted, card or ticket (e.g., via near-field radio-frequency waves). In some embodiments, receptacle 60 can “read” a payment token, such as a credit card, a prepaid cash card, or the like, providing payment from the patron for access to the seat. Image input device 62 can function in a similar manner, but rather than a patron inserting a card or ticket, a patron can hold a portion of a card or ticket (e.g., a barcode, computer-readable portion, printed indicia, etc.) near image input device 62 such that device 62 can obtain the appropriate data from the card or ticket. In some embodiments, rather than a card, ticket, or similar item, a patron can hold a cellular phone or other device having a display near image input device 62 to provide the appropriate data.

Audio input device 64 can be a microphone or similar device and is configured to receive voice signals or commands from a patron. For example, in some embodiments, a user can speak a numeric code to unlock or lock a seat. Furthermore, audio input device 64 can provide communications between a patron at seat 14 and a remote person (e.g., a seat reservation system operator, etc.). Audio output device 66 can be a speaker or other suitable device and provide audio outputs to users. For example, in response to receiving an input from a patron (e.g., by way of one or more of devices 60, 62, 64), device 66 can provide an audible indication of the availability of the seat, the availability of nearby seats, the future expected availability of the seat or nearby seats, and so on. Radio-frequency output device 67 can be an RFID tag, or a radio-frequency transmitter. For example, in response to receiving an input from a patron (e.g., by way of one or more of devices 60, 62, 64), device 67 can provide an electronic indication of the availability of the seat, the availability of nearby seats, the future expected availability of the seat or nearby seats, and so on.

Furthermore, one or more visual outputs can be provided by way of visual output device 68. For example, visual output device 68 can be configured to provide readable text (e.g., “open,” “reserved”), various color indicators (e.g., red/yellow/green), and the like. Device 32 can further include one or more buttons 69 to enable a patron to type in an access code, patron name, or other patron information. As discussed in greater detail below, based on inputs received via device 32, the status of seat 14 can be selectively controlled (i.e., seat 14 can be selectively reconfigured between an open, or available, configuration, and a closed, or unavailable, configuration).

Referring to FIGS. 7-8, in some embodiments, in addition to or rather than controlling one or more seats such as seat 14, access controls can be implemented for larger seating areas, such as seating areas 102, 104, 106 shown in FIG. 8. As discussed in greater detail below, seating areas 102, 104, 106 may be designated for use by certain types of patrons, such that access to one or more of seating areas 102, 104, 106 can be based on a wide variety of factors, such as reservation information (e.g., a reserved seat within the seating area, a ticket price, a reservation date) or patron demographic information (e.g., patron age, patron affiliations with certain teams or groups, etc.). In some embodiments, patron access to seating areas 102, 104, 106 can be controlled by access control devices 70 (e.g., a gate, turnstile, door, visual control indicator).

Referring to FIG. 7, according to one embodiment, access device 70 is configured to physically inhibit a patron from entering a seating area without the patron providing the proper inputs (e.g., credentials, reservation information). Access device 70 can include a pillar, or support 72, and a gate, or locking member 74. Locking member 74 can be moveable between an open position, in which patrons can freely access the associated seating area, and a closed position, in which patrons are inhibited from accessing the associated seating area. For example, as shown in FIG. 7, locking member 74 can be moveable between a raised position (as shown in FIG. 7) and a lowered position (such that locking member would pivot downward to be, for example, adjacent support 72). In alternative embodiments, locking member 74 can pivot or otherwise permit/prohibit access in a manner similar to a traditional turnstile, or in any other suitable way.

Referring further to FIG. 7, according to one embodiment access device 70 includes input/output device 76, which may in many respects be similar in function to input/output device 32 provided with seat 14. For example, as shown in FIG. 7, device 76 includes one or more of receptacle 78 (e.g., a slot, card reader), image input device 80 (e.g., a scanner, barcode reader, camera), audio input device 82, audio output device 84, radio-frequency output device 85, visual output device 86, and one or more buttons 88. According to various alternative embodiments, more of fewer components than those shown in FIG. 7 may be provided as part of device 76, and certain components may be integrated into single components or divided into sub-components.

Receptacle 78 can be a ticket reader, card reader, or similar device (e.g., a radio frequency identification (RFID) reader) configured to receive at least a portion of a ticket or card (e.g., a reservation) and “read” the ticket or card (in a manner similar to a credit card or keycard reader). Receptacle 78 may include a physical slot into which a card or ticket is inserted, or may electronically read a proximate, but not inserted, card or ticket (e.g., via near-field radio-frequency waves). In some embodiments, receptacle 78 can “read” a payment token, such as a credit card, a prepaid cash card, or the like, providing payment from the patron for access to the seat. Image input device 80 can function in a similar manner, but rather than a patron inserting a card or ticket, a patron can hold a portion of a card or ticket (e.g., a barcode, computer-readable portion, printed indicia, etc.) near image input device 80 such that device 80 can obtain the appropriate data from the card or ticket. In some embodiments, rather than a card, ticket, or similar item, a patron can hold a cellular phone or other device having a display near image input device 80 to provide the appropriate data.

Audio input device 82 can be a microphone or similar device configured to receive voice signals or commands from a patron. For example, in some embodiments, a user can speak a numeric code to gain access to a seating area. Furthermore, audio input device 82 can provide communications between a patron at access control device 70 and a remote person (e.g., a reservation system operator, etc.). Audio output device 84 can be a speaker or other suitable device and provide audio outputs to users. For example, in response to receiving an input from a patron (e.g., by way of one or more of devices 78, 80, 82), device 84 can provide an audible indication of the availability of the seating area, the availability of nearby seating areas, the future expected availability of the seating area or nearby seating areas, and so on. Radio-frequency output device 85 can be an RFID tag, or a radio-frequency transmitter. For example, in response to receiving an input from a patron (e.g., by way of one or more of devices 78, 80, 82), device 85 can provide an electronic indication of the availability of the seating area, the availability of nearby seating areas, the future expected availability of the seating area or nearby seating areas, and so on.

Furthermore, one or more visual outputs can be provided by way of visual output device 86. For example, visual output device 86 can be configured to provide readable text (e.g., “open,” “reserved”), various color indicators (e.g., red/yellow/green), and the like. Device 76 can further include one or more buttons 88 to enable a user to type in an access code, patron name, other patron information, etc. As discussed in greater detail below, based on inputs received via device 76, the status of access control device 70 can be controlled (i.e., device 70 can be selectively reconfigured between an open configuration and a closed configuration).

With respect to both seat 14 and access control device 70, it should be understood that reconfiguring the seat or device between an “open” position and a “closed” position can include physical manipulation of various components (e.g., locking members, gates, etc.), providing audible, visual, or tactile outputs intended to be discernible by one or more patrons, or combinations thereof Furthermore, in various alternative embodiments, any of these features may be used individually to provide a status indication of the seat or seating area.

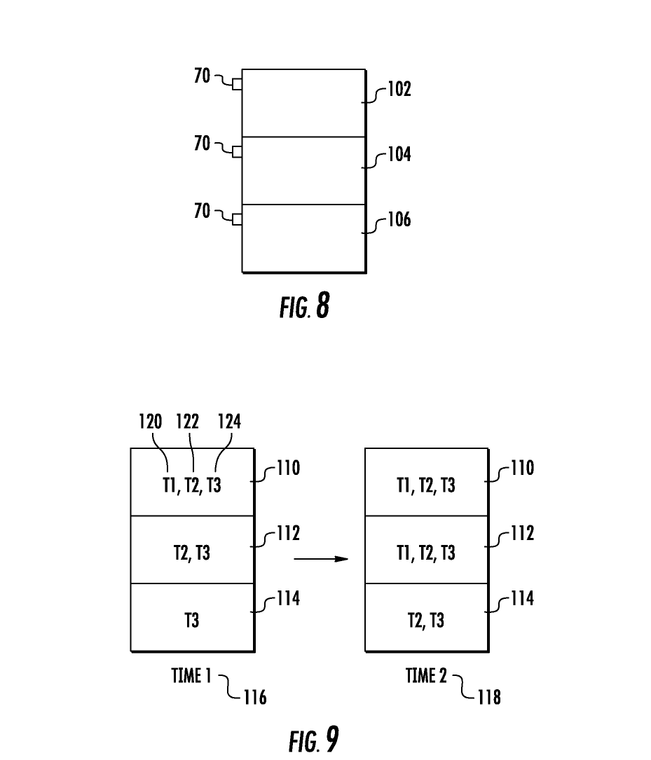

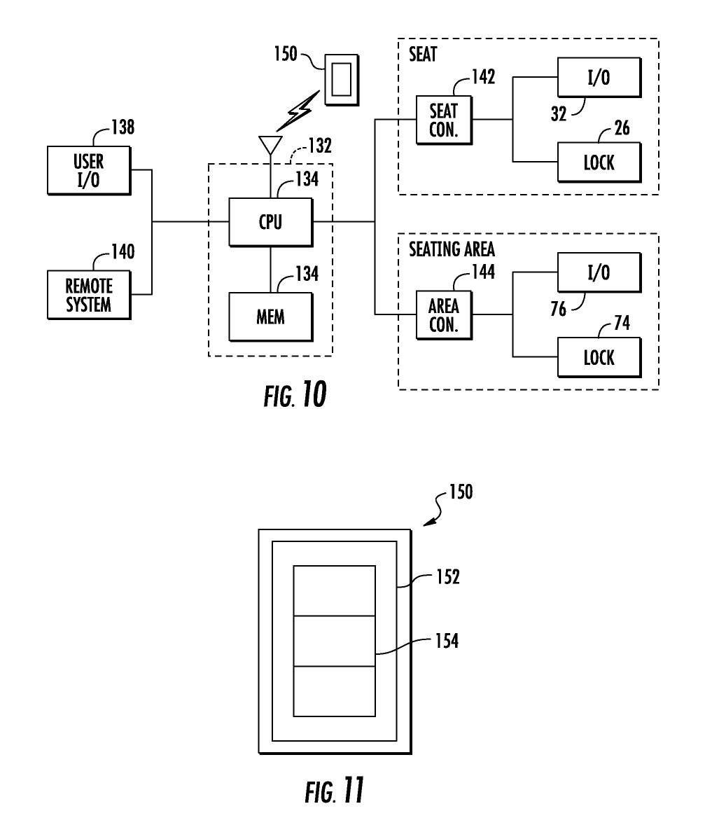

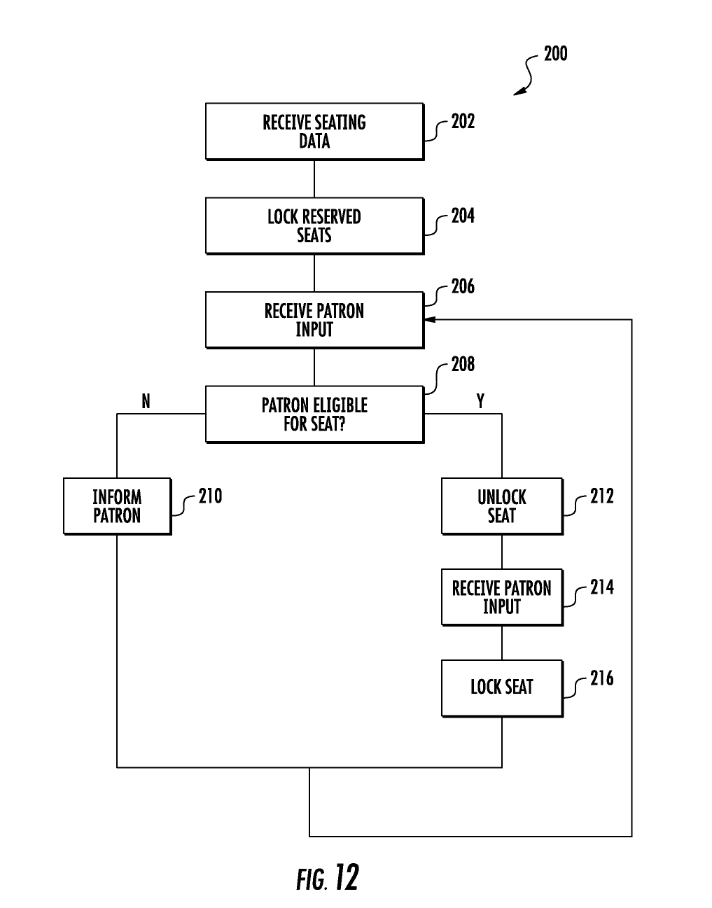

Referring now to FIG. 9, seating distributions for a number of seating areas 110, 112, 114 are shown during two different times 116, 118 and for various reservation levels 120, 122, 124. The seating distributions determine which patrons are eligible to seat in various seats within a venue. As shown in FIG. 9, at time 116, seating area 110 is accessible by patrons with reservation levels 120, 122, 124, seating area 112 is accessible by patrons with reservations levels 122, 124, and seating area 114 is accessible only by patrons with reservation level 124. At time 118, seating area 110 is accessible by patrons with reservation levels 120, 122, 124, seating area 112 is accessible by patrons with reservations levels 120, 122, 124, and seating area 114 is accessible by patrons with reservation levels 122, 124. In other words, between time 116 and time 188, patron accessibility to seating areas 112, 114 increased.

While FIG. 9 shows an increase in accessibility, it should be understood that the teachings herein extend to any changes in granting access to patrons in different seating areas at different points in time. This can be done for a variety of reasons. For example, if occupancy levels are initially low, access restrictions may be relaxed to encourage more patrons to sit closer to a stage, playing field, etc. Similarly, as an event (e.g., sporting or theatrical event) progresses, certain patrons may leave the venue, making it possible to permit additional patrons to fill the now vacated seats. The period of time between time 116 and time 118 can be based on a variety of factors, such as a set time period (e.g., 15 minutes, 30 minutes), detected changes in occupancy levels in one or more seating areas, event activities (e.g., events during a sporting event, theater event, vehicle transportation, etc.), or other factors.

The reservation levels define eligibility requirements for patrons and can similarly be based on a variety of factors, such as ticket price, patron demographics, etc. For example, referring further to FIG. 9, reservation level 120 may represent a relatively low ticket price, reservation level 122 may represent an intermediate ticket price, and reservation level 124 may represent a relatively high ticket price. As such, at time 116 (e.g., at the beginning of an event), patrons with reservation levels 124 can sit in any of seating areas 110, 112, and 114, patrons with reservation level 122 can sit only in seating areas 110 and 112, and patrons with reservation level 120 can sit only in seating area 110. As the event progresses, it may be desirable to open up seating areas typically reserved for relatively higher priced ticket holders to relatively lower priced ticket holders. As such, a change in seating distribution such as that shown in FIG. 9 may be implemented.

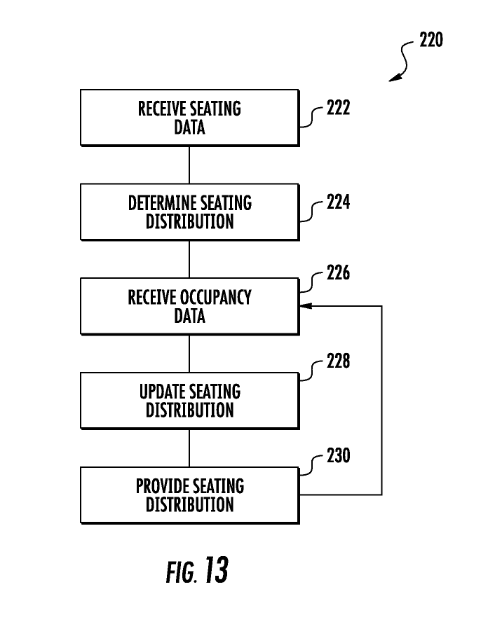

Referring now to FIG. 10, seating control system 11 is shown schematically according to one embodiment. Seating control system 11 includes seat control circuit 132 (e.g., a processing circuit, controller, etc.), which is configured to communicate with user input/output device 138 and remote system 140. Circuit 132 is further configured to communicate with seat controller 142 and area controller 144. Circuit 132 in one embodiment includes a processor 134 and memory 136. Circuit 132 can selectively control the status of one or more seats, such as seat 14, and one or more seating areas (e.g., seating areas 110, 112, 114) based on various types of data (e.g., a patron's reservation data, demographic data of the patron, event data, combinations thereof).

According to one embodiment, user input/output device 138 can include any suitable input/output device (e.g., microphone, speaker, keyboard, display screen, touch screen, etc.) capable of enabling communication between a user and control circuit 132. Device 138 can enable a user to enter changes in status for one or more seats or seating areas, based upon which circuit 132 can control seat controller 142 and area controller 144 accordingly. Device 138 can also provide communications (e.g., voice or data communications) between a remote operator (e.g., a remote reservations operator) and a patron located at a particular seat or seating area. Remote system 140 is in one embodiment a computer-based reservation enabling patrons to make reservations for one or more seats for an event, and is configured to provide reservation data regarding various patrons and events to circuit 132.

Seat controller 142 is configured to communicate with input/output device 32 of seat 14 (e.g., to receive reservation data for a particular patron at the seat) and control operation of locking device 26 based on various data, as discussed in detail above. For example, should a patron present a valid ticket for a seat to input/output device 32 (e.g., via a scanner, etc.), seat controller 142 can communicate the data to circuit 132 which, based on the acquired data, can send control signals to seat controller 142 to direct seat controller 142 to actuate locking device 26 to configure seat 14 into one of an open position and a closed position.

Similarly, area controller 144 is configured to communicate with input/output device 76 of area access control device 70 (e.g., to receive reservation data for a particular patron at the access point) and control operation of locking device 74 based on various data, as discussed in detail above. For example, should a patron present a valid ticket for a seating area to input/output device 76 (e.g., via a scanner, etc.), area controller 144 can communicate the data to circuit 132 which, based on the acquired data, can determine an appropriate status for the access point and send control signals to area controller 144, which can direct area controller 144 to actuate locking device 74 so as to permit/deny access to a particular patron and/or provide various outputs to a patron (e.g., indicating access information or restrictions to the patron).

In some embodiments, circuit 132 is further configured to communicate with one or more patron mobile devices 150 (e.g., mobile phones, cellular phones). As such, patrons can, for example, provide reservation data (e.g., ticket information) to circuit 132 and receive availability information for one or more seats or seating areas without having to be physically at the seat or seating area, thus making finding alternative seats less burdensome for patrons by potentially avoiding travel to unavailable seats or seating areas. As shown in FIG. 11, circuit 132 can be configured to provide seating chart data (e.g., by way of an interactive dynamic seating chart display) to mobile devices indicating other seats or seating areas 152, 145 that may be available for user by patrons.

In some embodiments, circuit 132 is configured to provide seating chart or distribution data to mobile device 150 upon receiving a request from a patron (e.g., via mobile device 150). In other embodiments, circuit 132 can provide periodic updates to the seating distribution data based on other factors, such as set time intervals, changes in occupancy levels, event activities, and so on. Furthermore, circuit 132 can enable patrons to remotely change a seating reservation, such that patrons can reserve alternative seats prior to leaving their current seats. Further yet, in some embodiments, circuit 132 can be configured to provide a display of available seats, and receive bid information from multiple patrons and award the seats to the highest bidder. For example, during a sporting event, first row seats may become available during the event, and circuit 132 can be configured to auction the seats to the highest bidding holder of lower priced tickets. Such bidding can occur prior to or during an event (e.g., to encourage lower price ticket/reservation holders to purchase discounted higher price tickets/reservations).

Referring now to FIG. 12, method 200 of controlling the status of one or more seats is shown according to one embodiment. First, seating data is received for a plurality of seats for an event (e.g., an event occurring at a venue having a number of seats) (202). The seating data can identify which patrons are eligible to sit in certain seats, what restrictions are placed on various seats (e.g., based on patron demographics such as age, gender, or group affiliations, based on ticket price, etc.), and so on. Based on the seating data, a portion of the seats can be locked, or otherwise identified as unavailable (204). In some embodiments, all seats are initially available, or unlocked, and based on the seating data, reserved seats are then moved to a locked or unavailable position. Locking or unlocking a seat can include a variety of actions, including moving a locking member, changing a visual indicator, locking/unlocking a seat rest in an upright position, providing an usher or attendant at the event with seat status data, and so on.

A patron can provide patron reservation data (206). For example, a patron can present a bar-coded ticket to a barcode reader associated with a particular seat. Based on the patron reservation data, a control circuit can determine whether or not the patron is eligible to sit in the particular seat (208). If the patron is not eligible to sit in the seat, the seat remains in the closed, or locked position, and the patron can be appropriately notified (210). In some embodiments, a visual or audible indication can be provided to a patron. If the patron is eligible to sit in the seat, the control circuit moves the seat from the closed, or locked position, to an open, or unlocked, position (212). As such, patrons who are ineligible to sit in the seat (e.g., patrons who do not have a ticket for a particular seat) are not allowed to sit in the seat, avoiding otherwise potentially uncomfortable situations between, for example, rightful ticketholders and people sitting in incorrect seats.

Referring further to FIG. 12, a patron may wish to leave a seat temporarily or permanently. As such, the control circuit may receive an input indicating that the seat has been vacated (214). The input may include a signal from an occupancy sensor or another suitable device. In response to the seat being vacated, the control circuit moves the seat back to the closed, or locked, position (216). Upon the patron returning, or upon the arrival of a different eligible patron (206), the control circuit can again determine patron eligibility (208) and adjust the status of the seat accordingly (210, 212). In some embodiments, following the passage of a designated period of time, the control circuit can “decide” that the patron is unlikely to return to the seat, and adjust the seat status to make it available to other patrons. This can involve notation in a database, activation of a seat-based indicator showing the seat to be available, changing a locking member to an open or unlocked position, etc.

In one embodiment, the method of FIG. 12 can be used when particular seats are assigned to particular patrons prior to an event (e.g., such that there is a one to one correspondence between seats and reservations for a particular patron). In other embodiments, the method of FIG. 12 can be used when a number of seats are available to a particular patron (e.g., on a first come, first serve basis). As such, after a patron initially sits in a desired seat, the control circuit can associate the patron with that particular seat such that only the particular patron can utilize the seat (i.e., move the seat from the closed to open position).

Referring to FIG. 13, method 220 of operating a seating control system is shown according to one embodiment. Seating data is received (222). The seating data can include reservation data for a number of patrons, or any of the other seating or reservation data discussed elsewhere herein. Based on the seating data, a control system determines an initial seating distribution (224). The initial seating distribution may, for example, provide for a one-to-one correspondence between patrons and assigned seats. Occupancy data is received (226). The occupancy data may reflect current occupancy levels for one or more seats, one or more seating areas, and so on. Furthermore, the occupancy data can be received prior to and during an event. Occupancy data may be accumulated from seat occupancy data, may be based on numbers of patrons entering/leaving the venue or seating area, may be based on concessions sales, etc.

Based on the occupancy data, the seating distribution can be updated (228). For example, referring back to FIG. 9, an initial seating distribution is shown at time 116, and the seating distribution shown at time 118 may reflect an updated seating distribution determined based on occupancy levels at time 118. The updated seating distribution may be provided to some or all of the patrons at an event (230). For example, in some embodiments, all patrons may be provided with updated seating distribution (e.g., via email, via text message, web page). Alternatively, only patrons eligible for alternative seating based on the updated seating distribution are provided with the updated seating distribution. In yet further embodiments, the updated seating distribution can be provided based on requests for such information from patrons.

As shown in FIG. 13, after distributing an updated seating distribution, updated occupancy data may again be received (226), such that the seating distribution can be further updated (228) and distributed to patrons (230). This method can continue for the duration of the event, and the time lapse between updates of the seating distribution can be based on any of the variety of factors discussed elsewhere herein, including a set time period, event activity (e.g., progress of a sporting event such as halftime of a football game), and so on.

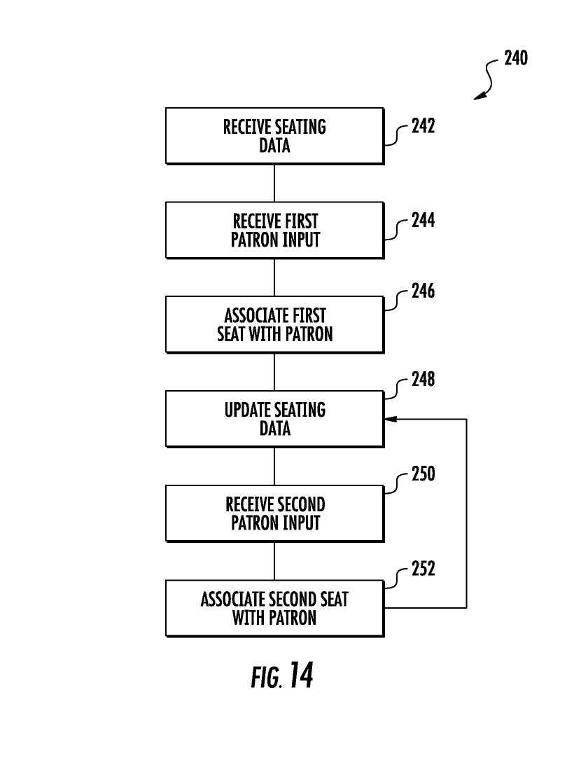

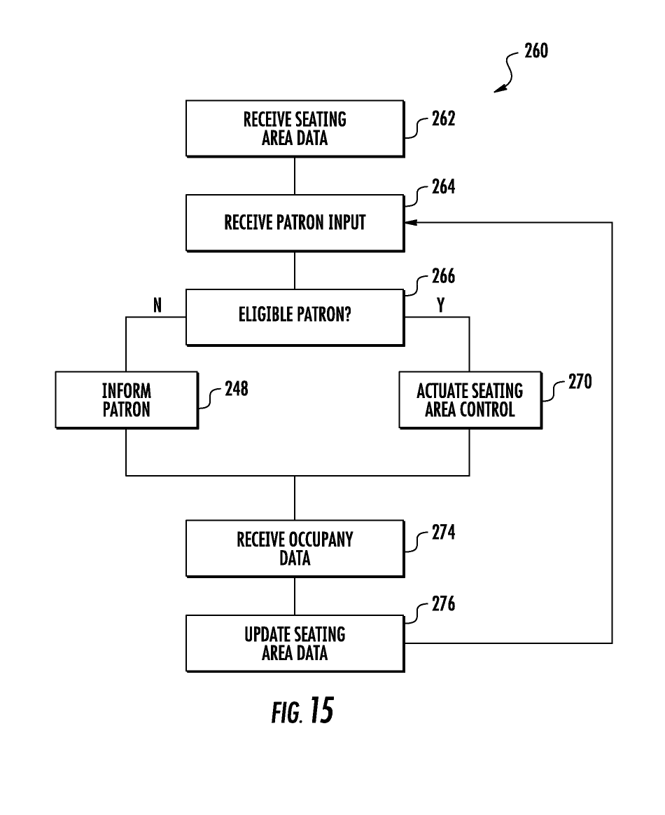

Referring to FIG. 14, method 240 of controlling seat reservations is shown according to another embodiment. Seating data is received (242). The seating data may include any of the types of seating or reservation data discussed elsewhere herein. A first patron input is received at a first seat (244). For example, a patron may present a ticket or other reservation information at an input/output device (e.g., scanner, etc.) of a first seat. A control circuit associates the patron with the first seat such that only the first patron can sit in the first seat (246). A seating distribution may be updated, providing the patron with one or more alternate seats that are available (248). Based on the updated seating distribution, the patron may decide to move seats. As such, a second patron input may be received for a second, alternate seat (250). Receiving the second input may include receiving a reservation remotely from the patron's mobile device, receiving an input directly at the second seat, or any other suitable means. Based on receiving the second patron input regarding the alternate seat, the control circuit associates the alternate seat with the patron and disassociates the patron with the previous first seat (252). As shown in FIG. 14, as the seating distribution continues to change, the patron may choose to continue to select alternate seats, and the control circuit may in turn continue to associate the patron with the respective seats.

Referring to FIG. 15, method 260 of operating a seating system is shown according to another embodiment. Seating area data is received (262). Seating area data can define what reservation levels are required for patrons to sit in various seating areas with a venue. A patron can provide an input to, for example a seating area access control device (264). Based on the input, a control system or other device can determine if the patron is eligible to sit in the seating area (266). If the patron is not eligible to sit in the particular seating area, an appropriate notification can be provided to the patron (e.g., by way of the access control device) (268). If the patron is eligible to sit in the seating area, the access control device can be actuated so as to enable the patron to enter the seating area (270). During an event, occupancy data may be received periodically (274). The occupancy data can indicates areas of lower occupancy for which it may be desirable to provide additional access to patrons. As such, based on the occupancy data, the seating area data can be updated (e.g., modifying the seating eligibility requirements for patrons) (276) and distributed to patrons. As such, in certain circumstances, a patron that was initially not eligible to sit in a particular seating area may later be eligible to sit in the seating area. This dynamic control over the seating distribution can provide enhanced seating opportunities for patrons.

It should be understood that whether a patron is eligible to sit in particular seat or seating area can be based on a wide variety of factors, including any of those discussed above. For example, in some embodiments, patrons may purchase tickets with individual assigned seats, such that there is a one to one correspondence between patrons and seats. In other embodiments, seating in certain seating areas can be restricted based on ticket / reservation price, patron demographics, current occupancy levels, or other factors. For example, in some embodiments, a seating area may be limited to permit only certain demographics of patrons to sit in the area, such as a certain number of children over or under a particular age, high concentrations of teenage boys, only patrons of legal drinking age, only patrons associated with a particular sports team or other group, etc.

Furthermore, seating restrictions may be provided to prevent certain undesirable seating situations. For example, in some embodiments, a tall person may be prohibited from sitting directly in front of a shorter person. In other embodiments, people differing in age by more than a threshold amount of years may be prohibited from sitting adjacent or near each other. Such determinations may be made based on demographic data (e.g., age, sex, familial relations, team affiliations) collected, for example, by a reservation system (e.g., remote reservation system 140) upon a patron making an initial reservation. As such the percent of certain age groups, sexes, fans of a particular team, can be limited for certain seats or seating areas. Such demographically based seating restrictions may be based on data gathered during an event, not only of pre-event reservation data. Accordingly, demographically unfortunate seating situations may be prevented from developing throughout an event, e.g., partially through a movie, in the later innings of a baseball game, or the like.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A seating system for selectively reserving seats during an event, comprising:
a seating control system configured to:
place one or more seats from a plurality of seats in an open position, such that a patron is able to sit in the one or more seats;
receive reservation data identifying reserved seats from the plurality of seats; and
place each reserved seat into a closed position, such that a patron is not able to sit in the reserved seat, based on the reservation data.

2-3. (canceled)

4. The system of claim 1, wherein for each reserved seat, the seating control system is further configured to:
receive a first input from a patron; and
place the reserved seat into the open position based on the first input.

5-7. (canceled)

8. The system of claim 4, wherein the reserved seat comprises an input device configured to receive the first input.

9. The system of claim 8, wherein the input device includes a scanning device.

10-11. (canceled)

12. The system of claim 8, wherein the input device includes an image capture device.

13-15. (canceled)

16. The system of claim 4, wherein for each reserved seat the seating control system is further configured to:
receive a second input indicating the patron has vacated the reserved seat; and
place the reserved seat into the closed position based on the second input.

17. The system of claim 16, wherein the reserved seat includes an occupancy sensor configured to receive the second input.

18-19. (canceled)

20. The system of claim 16, wherein for each reserved seat the seating control system is further configured to:
receive a third input indicating the patron has occupied an alternate seat; and
place the reserved seat into the open position based on the third input.

21. The system of claim 16, wherein for each reserved seat the seating control system is further configured to:
receive a third input indicating the seat has remained in the closed position for more than a specified duration; and
place the reserved seat into the open position based on the third input.

22. The system of claim 1, wherein each of the reserved seats includes a locking member configured to prevent use of the reserved seat when the reserved seat is in the closed position.

23-26. (canceled)

27. The system of claim 1, wherein each of the reserved seats includes a storage compartment configured to be accessible by a patron when the reserved seat is in the open position and inaccessible by a patron when the reserved seat is in the closed position.

28-30. (canceled)

31. The system of claim 1, wherein the seating control system is configured to receive the reservation data during the event.

32-36. (canceled)

37. A seating reservation system for dynamically reserving seats for an event, comprising:
a seat including an indicator device, the indicator device configured to provide at least one of a first indication indicating the seat is unreserved and a second indication indicating the seat is reserved; and
a seating control system configured to receive reservation data regarding the seat and to control operation of the indicator device to provide at least one of the first indication and the second indication based on the reservation data.

38-46. (canceled)

47. The system of claim 37, wherein the indicator device is configured to change between providing the first indication and providing the second indication based on an input regarding a patron.

48. The system of claim 47, wherein the input is received at the seat.

49. The system of claim 48, wherein the seat includes an input device, and wherein the input is received by the input device.

50. The system of claim 49, wherein the input device includes a receptacle configured to receive a portion of a reservation indicator.

51-54. (canceled)

55. The system of claim 49, wherein the input device is configured to receive a radio frequency identification.

56. (canceled)

57. The system of claim 49, wherein the input device includes an occupancy sensor.

58-59. (canceled)

60. The system of claim 37, wherein the indicator device is configured to change between providing the first indication and providing the second indication based on the seat being vacant for a period of time.

61. The system of claim 37, wherein the indicator device is configured to change between providing the first indication and providing the second indication based on activity regarding an event at a venue.

62. The system of claim 61, wherein the activity includes a predetermined time during a sporting event.

63. (canceled)

64. The system of claim 37, wherein the seat control system is configured to control operation of the indicator device based on updated reservation data received during an event.

65. The system of claim 64, wherein the seat control system is configured to receive the updated reservation data from a remote source.

66. The system of claim 65, wherein the remote source includes a mobile device of a patron.

67. A seating system comprising:
a seating control system configured to:
receive reservation data for an event at a venue;
determine a first seating distribution for the venue based on the reservation data, the first seating distribution defining first eligibility requirements for patrons to sit in a plurality of seats; and
determine a second seating distribution for the venue during the event, the second seating distribution defining second eligibility requirements for patrons to sit in the plurality of seats.

68-73. (canceled)

74. The system of claim 67, wherein the first seating distribution is based on a predicted occupancy level for the venue determined prior to start of the event.

75. The system of claim 67, wherein the seating control system is further configured to receive occupancy data for the venue during the vent and determine the second seating distribution based on the occupancy data.

76-77. (canceled)

78. The system of claim 75, wherein the occupancy data is received from the plurality of seats.

79. The system of claim 78, wherein each of the plurality of seats includes an occupancy sensor configured to provide occupancy data for the seat to the seating control system.

80. The system of claim 67, wherein the seating control system is configured such that for a portion of the plurality of seats, more patrons are eligible to sit in the portion of seats based on the second seating distribution than based on the first seating distribution.

81-85. (canceled)

86. The system of claim 67, wherein the plurality of seats are provided in different seating areas, each seating area including an access control device.

87. (canceled)

88. The system of claim 86, wherein the access control device for each seating area is configured to provide a patron an indication of whether the patron is eligible to sit in the seating area based on the first and second seating distributions.

89. The system of claim 86, wherein the access control device for each seating area includes an output device configured to provide a patron an indication of whether the patron is eligible to sit in the seating area.

90-102. (canceled)

103. The system of claim 86, wherein the access control device for each seating area includes a locking member configured to be moveable between first and second positions based on whether a patron is eligible to sit in the seating area.

104-195. (canceled)
